(19) United States
(12) Patent Application Publication
(10) Pub. No.: US 2025/0200585 A1
(43) Pub. Date: Jun. 19, 2025

(54) AUTOMATED AGENT CONTROLS

(71) Applicant: Scaled Cognition, Inc., Amesbury, MA (US)

(72) Inventors: Dan Klein, Berkeley, CA (US); Mathew Gardner, Irvine, CA (US); Emmanouil Antonios Platanios, Fremont, CA (US); Mitchell Stern, Berkeley, CA (US); Adam Pauls, Berkeley, CA (US)

(73) Assignee: Scaled Cognition, Inc., Amesbury, MA (US)

(21) Appl. No.: 18/545,712

(22) Filed: Dec. 19, 2023

(51) Int. Cl. G06Q 30/01; G06F 40/20; H04L 51/216

(52) U.S. Cl. CPC G06Q 30/01; G06F 40/20; H04L 51/216

(57) ABSTRACT

The system provides improved controls for an automated agent by generating a declarative specification for an automated agent. The declarative specification is generated based at least in part from previous conversation data associated with interactions between an automated agent and a customer. The policies may include general policies and specific policies. A general policy is one that is applied to all automated agents. After creating the declarative specification, an automated agent can interact with a customer in an interaction based on the specification. The automated agent responses are evaluated based on checklists associated with the policies to determine if a response was proper.

### BACKGROUND

Customer service assistant applications are becoming more common and adept at assisting customers with their needs. The customer service applications often interact with a customer through a chat application, in which the agent and customer may exchange text messages with each other. In a typical exchange, a customer begins by entering an inquiry into a chat application. The customer service assistant application receives and processes the inquiry, generates a response, and transmits the response to the user.

It can be difficult for a customer service assistant application to correctly parse a user inquiry, generate the proper response, and provide the proper response to a user. Often times, the customer service response to a user is either not helpful, times out, or provides a response that is not relevant to the inquiry. What is needed is an improved customer service assistant.

### SUMMARY

The present technology, roughly described, provides improved controls for an automated agent. A declarative specification is generated for an automated agent. The declarative specification is generated based at least in part from previous conversation data associated with interactions between an automated agent and a customer. Examples from the previous conversation data are used to create policies, and the policies are combined to create the declarative specification.

In some instances, the declarative specification is created from one or more policies or controls. The policies may include general policies and specific policies. A general policy is one that is applied to all automated agents. For example, a general policy may include a requirement that the owner of a hotel reservation is not to be provided to a customer until the customer provides his or her identity. A specific policy can include a requirement that is applied only in specific situations. An example of a specific policy is that on a specific holiday weekend in California, a particular hotel brand may not allow cancellations less than two weeks in advance.

After creating the declarative specification, an automated agent can interact with a customer in an interaction. During the interaction, when the customer has an inquiry, the automated agent system determines an action or response by the automated agent based on the one or more generated policies. In some instances, a customer request, one or more relevant policies, and instructions as to what is the best response are used to generate a prompt provided to a large language model (LLM). The large language model processes the request, provides a response, and the automated agent system can perform an action based on the response.

The present system can audit or evaluate past or proposed responses by an automated agent. In some instances, a checklist can be generated for each policy that is applied to and/or followed by an automated agent. The checklist can be a list of items in the form of statements, rules, or other portions of the overall policy. In some instances, the checklist can be generated by parsing the policy into sentences, statements, or other portions by a parsing machine, LLM, or other mechanism.

Each item in the checklist can be checked against the corresponding action and/or response of the automated agent to determine if the checklist item was followed properly. In some instances, one or more LLMs may be used to process the checklist items and automated agent actions and/or responses. A single LLM can be used to process the entire checklist, a separate LLM can process each checklist item, or some other combination of LLMs can be used to process a checklist against the automated agent actions. If an automated agent action is proper in view of a checklist, then the agent or response is validated. If the automated agent action is not proper in view of one or more checklist items, a prompt may be generated and provided to an LLM that includes the checklist, the automated agent action or response, and a request for what would be a proper action and/or response by the automated agent in view of the violated checklist item.

In some instances, the present technology performs a method for providing controls for an automated agent. The method begins with generating declarative specification for an automated agent, wherein the declarative specification includes a general policy and a specific policy. Conversation data is received by the system, wherein the conversation data is associated with an interaction between the automated agent and a customer. The automated agent applies the declarative specification during the interaction. The system then determines, by one or more machine learning mechanisms stored and executed on one or more servers, whether the declarative specification was followed by the automated agent during the interaction.

In some instances, the present technology includes a non-transitory computer readable storage medium having embodied thereon a program, the program being executable by a processor to provide controls for an automated agent. The method begins with generating declarative specification for an automated agent, wherein the declarative specification includes a general policy and a specific policy. Conversation data is received by the system, wherein the conversation data is associated with an interaction between the automated agent and a customer. The automated agent applies the declarative specification during the interaction. The system then determines, by one or more machine learning mechanisms stored and executed on one or more servers, whether the declarative specification was followed by the automated agent during the interaction.

In some instances, the present technology includes a system having one or more servers, each including memory and a processor. One or more modules are stored in the memory and executed by one or more of the processors to generate declarative specification for an automated agent, the declarative specification including a general policy and a specific policy, receive conversation data, the conversation data associated with an interaction between the automated agent and a customer, the automated agent applying the declarative specification during the interaction, and determine, by one or more machine learning mechanisms stored and executed on one or more servers, whether the declarative specification was followed by the automated agent during the interaction.

### BRIEF DESCRIPTION OF FIGURES

FIG. 1 is a block diagram of a system that provides automated agent controls.

FIG. 2 is a block diagram of an automated agent application.

FIG. 3 is a block diagram of a conversation manager.

FIG. 4 is a block diagram of data flow for a machine learning model.

FIG. 5 is a method for implementing controls for an automated agent.

FIG. 6 is a method for generating a declarative specification.

FIG. 7 is a method for initiating an automated agent from a declarative specification.

FIG. 8 is a method for engaging in a conversation with a customer by an automated agent.

FIG. 9 is a method for evaluating an automated agent response based on controls.

FIG. 10 is a block diagram of a computing environment for implementing the present technology.

### DETAILED DESCRIPTION

The present technology, roughly described, provides improved controls for an automated agent. A declarative specification is generated for an automated agent. The declarative specification is generated based at least in part from previous conversation data associated with interactions between an automated agent and a customer. Examples from the previous conversation data are used to create policies, and the policies are combined to create the declarative specification.

In some instances, the declarative specification is created from one or more policies or controls. The policies may include general policies and specific policies. A general policy is one that is applied to all automated agents. For example, a general policy may include a requirement that the owner of a hotel reservation is not to be provided to a customer until the customer provides his or her identity. A specific policy can include a requirement that is applied only in specific situations. An example of a specific policy is that on a specific holiday weekend in California, a particular hotel brand may not allow cancellations less than two weeks in advance.

After creating the declarative specification, an automated agent can interact with a customer in an interaction. During the interaction, when the customer has an inquiry, the automated agent system determines an action or response by the automated agent based on the one or more generated policies. In some instances, a customer request, one or more relevant policies, and instructions as to what is the best response are used to generate a prompt provided to a large language model (LLM). The large language model processes the request, provides a response, and the automated agent system can perform an action based on the response.

The present system can audit or evaluate past or proposed responses by an automated agent. In some instances, a checklist can be generated for each policy that is applied to and/or followed by an automated agent. The checklist can be a list of items in the form of statements, rules, or other portions of the overall policy. In some instances, the checklist can be generated by parsing the policy into sentences, statements, or other portions by a parsing machine, LLM, or other mechanism.

Each item in the checklist can be checked against the corresponding action and/or response of the automated agent to determine if the checklist item was followed properly. In some instances, one or more LLMs may be used to process the checklist items and automated agent actions and/or responses. A single LLM can be used to process the entire checklist, a separate LLM can process each checklist item, or some other combination of LLMs can be used to process a checklist against the automated agent actions. If an automated agent action is proper in view of a checklist, then the agent or response is validated. If the automated agent action is not proper in view of one or more checklist items, a prompt may be generated and provided to an LLM that includes the checklist, the automated agent action or response, and a request for what would be a proper action and/or response by the automated agent in view of the violated checklist item.

In some instances, the process for preparing and evaluating a response is iterative. Hence, if a response is determined to not be proper, a revised response is generated. If the revised response continues to be improper in view of one or more checklist items, then the system can retry until either (a) a proper response has been generated or (b) some limitation on maximum retries has been reached: total time exceeded, compute budget exceeded, tried 100 times, and so forth. If the limit is reached, then the system can deliver a response to the customer which conveys that an error occurred.

The present system is applicable in many scenarios and has several applications. An application towards a conversation is discussed herein for purposes of example. However, other applications and uses of the present system are possible, including but not limited to workflow automation and personalized tutoring, and the scope of the present system is not intended to be limited to conversation or any other single application.

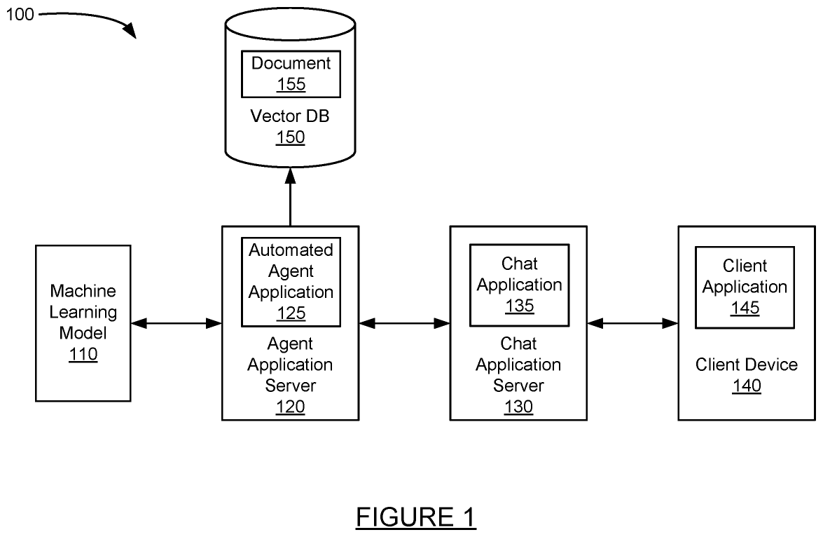

FIG. 1 is a block diagram of a system that provides automated agent controls. System 100 of FIG. 1 includes machine learning model 110, agent application server 120, chat application server 130, client device 140, and vector database 150.

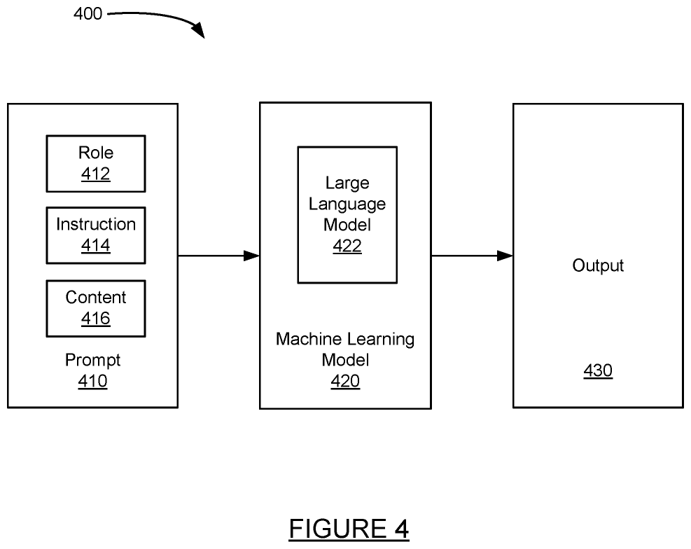

Machine learning model 110 may include one or more models or prediction engines that may receive an input, process the input, and predict a result based on the input. In some instances, machine learning model 110 may be implemented on agent application server 120, on the same physical or logical machine as automated agent application 125. In some instances, machine learning model 110 may be implemented by a large language model, on one or more servers external to agent application server 120. Implementing the machine learning model 110 as one or more large language models is discussed in more detail with respect to the method of FIG. 4.

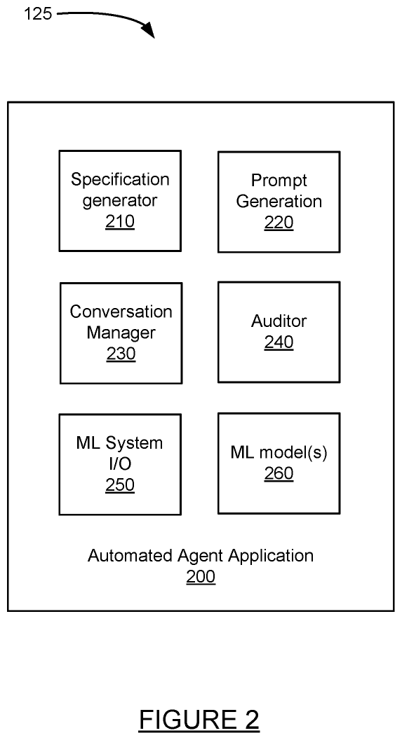

Agent application server 120 may include an automated agent application 125, and may communicate with machine learning model 110, chat application server 130, and vector database 150. Automated agent application 125 may be implemented on one or more servers 120, may be distributed over multiple servers and platforms, and may be implemented as one or more physical or logical servers. Automated agent application 125 may include several modules that implement the functionality described herein. More details for automated agent application 125 is discussed with respect to FIG. 2.

Chat application server 130 may communicate with agent application server 120, client device 140, and may implement a conversation and/or interaction over a network, such as for example a “chat,” between an automated agent application provided by agent application server 120 and a customer entity. The customer entity may be a simulated customer, or an actual customer. When implemented as an actual customer, the chat application may communicate with a customer through client application 145 on client device 140, which may communicate with chat application 125 on chat application server 130. Client application 145 may be implemented as an app or a network browser on a computing device such as a smart phone, tablet computer, laptop computer, or other computer, or some other application.

Vector database 150 may be implemented as a data store that stores vector data. In some instances, vector database 135 may be implemented as more than one data store, internal to system 103 and exterior to system 103. In some instances, a vector database can serve as an LLMs' long-term memory and expand an LLMs' knowledge base. Vector database 135 can store private data or domain-specific information outside the LLM as embeddings. When a user asks a question to an administrative assistant, the system can have the vector database search for the top results most relevant to the received question. Then, the results are combined with the original query to create a prompt that provides a comprehensive context for the LLM to generate more accurate answers. Vector database 150 may include data such as prompt templates, instructions, training data, and other data used by automated agent application 125 and machine learning model 110.

In some instances, the present system may include one or more additional data stores, in place of or in addition to vector database 150, at which the system stores searchable data such as instructions, private data, domain-specific data, and other data.

Each of model 110, servers 120-130, client device 140, and vector database 150 may communicate over one or more networks. The networks may include one or more the Internet, an intranet, a local area network, a wide area network, a wireless network, Wi-Fi network, cellular network, or any other network over which data may be communicated.

In some instances, one or more of machines associated with 110, 120, 130 and 140 may be implemented in one or more cloud-based service providers, such as for example AWS by Amazon Inc, AZURE by Microsoft, GCP by Google, Inc., Kubernetes, or some other cloud based service provider.

FIG. 2 is a block diagram of an automated agent application. Automated agent application 200 of FIG. 2 provides more detail for automated agent application 125 of the system of FIG. 1. Application 200 of FIG. 2 includes specification generator 210, prompt generation 220, conversation manager 230, auditor 240, machine learning system I/O module 250, and machine learning models 260.

Specification generator 210 may generate a declarative specification. The declarative specification may be generated to include general policies and specific policies. In some instances, the policies may be generated based on past conversations with users or simulated users. Conversations with past users, real or simulated, state data, and other data associated with the conversation (collectively conversation data) are analyzed and used to extract examples related to specific items associated with providing a service. General and specific policies can be created from the examples extracted from the conversation data. General policies are policies applied to all states of an automated agent. These may include permissions granted to a customer before providing information to the customer. A specific policy generated from the examples may be applied as needed based on the specific state or set of conditions that exist within a conversation. Specific policies may relate to geolocations, limitations, and other policies. The declarative specification may also indicate whether and in what order APIs should be called when answering a question. For example, the order of APIs may include business documents related to the entity providing the automated agent, general web search, and so forth.

Prompt generation 220 may operate to generate a prompt to be fed into a large language model. A prompt may include one or more of request, role data associated with the role that the automated agent is to have during a conversation, a user inquiry, instructions retrieved based on the user inquiry, audit data, and optionally other data. The request may indicate what the large language model is requested to do, for example find relevant instructions, determining a next state from the current state, determine a response for a user inquiry, select a function or program to be executed, perform an audit of a predicted response, or some other goal. A role is a level of permission and authority that the automated agent has in a customer service capacity, such as a bottom level agent, a supervisor, a manager, or some other role. The instructions may include the rules, guidelines, and other guides for controlling what an automated agent can and cannot do when assisting a customer through a conversation or chat. Other data that may be included in a prompt, in addition to a request, role, and instructions, may include a series of actions not to do (e.g., a series of actions determined to be incorrect by an auditor).

Conversation manager 230 may manage a conversation between an automated agent application 125 and client application 145. In some instances, conversation manager 250 may be implemented at least in part by an automated agent application 125. In some instances, conversation manager 250 may be implemented at least in part in chat application 125. The conversation manager may have capabilities such as parsing text input, detecting meaning within parsed text, and managing dialogue to and from a participant in the conversation. More details for conversation manager 250 are discussed with respect to the conversation manager of FIG. 4.

Auditor 240 may audit a predicted response from an automated agent to a customer at client application 145. In some instances, the auditor may access or create a checklist associated with a policy, and manage an evaluation of the automated agent in view of the list to determine if the automated agent properly followed the policy.

In some instances, the auditor may confirm if instructions followed by the automated agent were relevant, if the instructions were followed properly, and confirm other aspects related to generating a response to a customer inquiry. In some instances, the instructions may be created based on a general or specific policy, created based on a checklist item, or be separate from a policy or checklist item.

Machine learning system I/O 250 may communicate with one or more machine learning models 110 280. ML system I/O 270 may provide prompts or input to and receive or retrieve outputs from machine learning models 110 and 280.

Machine learning (ML) model(s) 260 may include one or more machine learning models that generate predictions for state machines 210, and receive prompts, instructions and requests to provide a response to particular inquiry, as well as perform other tasks. The machine learning models 260 can include one or more LLMs, as well as a combination of LLMs and ML models.

Modules illustrated in automated agent application 200 are exemplary, and could be implemented in additional or fewer modules. Automated agent application 200 is intended to at least implement functionality described herein. The design of specific modules, objects, programs, and platforms to implement the functionality is not specific and limited by the modules illustrated in FIG. 2.

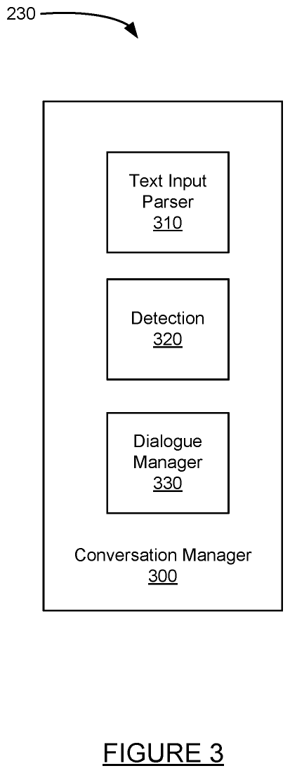

FIG. 3 is a block diagram of a conversation manager. Conversation manager 300 provides more detail for conversation manager 250 of the block diagram of FIG. 2. Conversation manager 300 includes a text input parser 310, detection module 320, and dialogue manager 330. In some instances, conversation manager 300 may be implemented within chat application 125, automated agent application 135, or distributed between applications 125 and 135.

Text input parser 310 may parse text input provided by client to chat application 135. Detection 320 may analyze the parsed text to determine intent and meaning of the parsed text. Dialogue manager 330 may manage input received from client application 145 an automated agent application 125 into the conversation between them.

FIG. 4 is a block diagram of data flow for a machine learning model. The method of FIG. 4 includes prompt 410, machine learning model 420, and output 430.

Prompt 410 of FIG. 4 can be provided as input to a machine learning model 420. A prompt can include information or data such as a role 412, instructions 414, and content 416. The role indicates the authority level at which the automated agent is to assume while working to assist a user. For example, a role can include an entry-level customer service representative, a manager, a director, or some other customer service job with a particular level of permissions and rules that apply to what they can do and can't do when assisting a customer.

Instructions 414 can indicate what the machine learning model (e.g., a large language model) is supposed to do with the other content provided in the prompt. For example, the machine learning model instructions may request, via instructions 414, an LLM to select the most relevant instructions from content 230 to train or guide a customer service representative having a specified role 210, determine if a predicted response was generated with each instruction followed correctly, determine what function to execute, determine whether or not to transition to a new state within a state machine, and so forth. The instructions can be retrieved or accessed from document 155 of vector database 150.

Content 416 may include data and/or information that can help a ML model or LLM generate an output. For an ML model, the content can include a stream of data that is put in a processable format (for example, normalized) for the ML model to read. For an LLM, the content can include a user inquiry, retrieved instructions, policy data, checklist and/or checklist item data, programs and functions executed by a state machine, results of an audit or evaluation, and other content. In some instances, where only a portion of the content or a prompt will fit into an LLM input, the content and/or other portions of the prompt can be provided to an LLM can be submitted in multiple prompts.

Machine learning model 420 of FIG. 4 provides more detail for machine learning model 110 of FIG. 1. The ML model 420 may receive one or more inputs and provide an output. In some instances, the ML model may predict an output in the form of whether a policy was followed, whether a particular instruction is relevant, or some other prediction.

ML model 420 may be implemented by a large language model 422. A large language model is a machine learning model that uses deep learning algorithms to process and understand language. LLMs can have an encoder, a decoder, or both, and can encode positioning data to their input. In some instances, LLMs can be based on transformers, which have a neural network architecture, and have multiple layers of neural networks. An LLM can have an attention mechanism that allows them to focus selectively on parts of text. LLMs are trained with large amounts of data and can be used for different purposes.

The transformer model learns context and meaning by tracking relationships in sequential data. LLMs receive text as an input through a prompt and provide a response to one or more instructions. For example, an LLM can receive a prompt as an instruction to analyze data. The prompt can include a context (e.g., a role, such as ‘you are an agent’), a bulleted list of itemized instructions, and content to apply the instructions to.

In some instances, the present technology may use an LLM such as a BERT LLM, Falcon 30B on GitHub, Galactica by Meta, GPT03 by OpenAI, or other LLM. In some instances, machine learning model 115 may be implemented by one or more other models or neural networks.

Output 430 is provided by machine learning model 420 in response to processing prompt 410 (e.g., an input). For example, when the prompt includes a request that the machine learning model identify the most relevant instructions from a set of content, the output will include a list of the most relevant instructions. In some instances, when the prompt includes a request that the machine learning model determine if an automated agent properly followed a set of instructions, a policy, or a checklist item during a conversation with a user, the machine learning model may return a confidence score, prediction, or other indication as to whether the instructions were followed correctly by the automated agent.

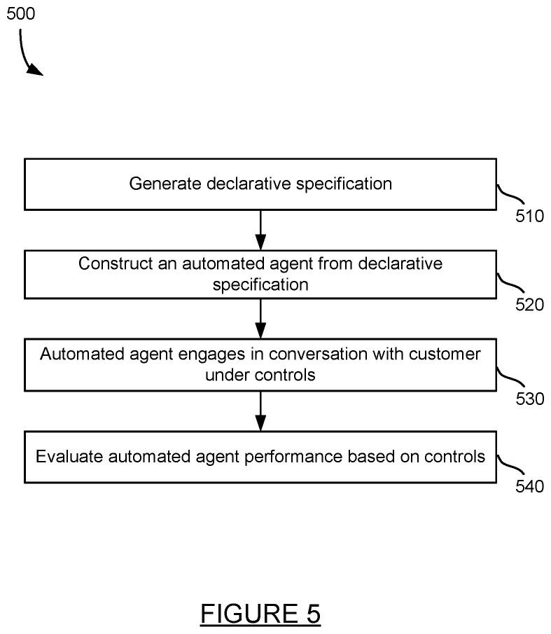

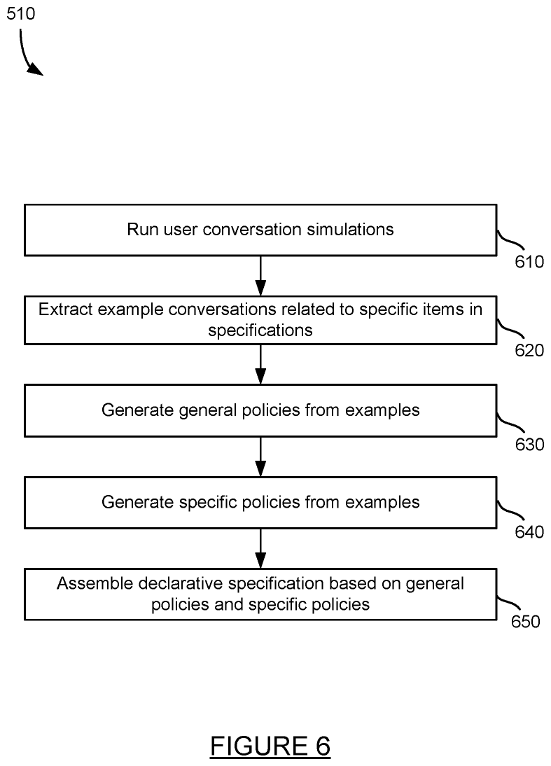

FIG. 5 is a method for implementing controls for an automated agent. The method of FIG. 5 may be performed at least in part by automated agent application 125 of the system of FIG. 1. First, a declarative specification is generated at step 510. The declarative specification can be based on examples extracted from a conversation between an automated agent and a human user or simulated user, a simulated conversation, or other conversation data. The policies may include general policies applied to all states and specific policies applied to a particular situation. More detail for generating a declarative specification is discussed with respect to the method of FIG. 6.

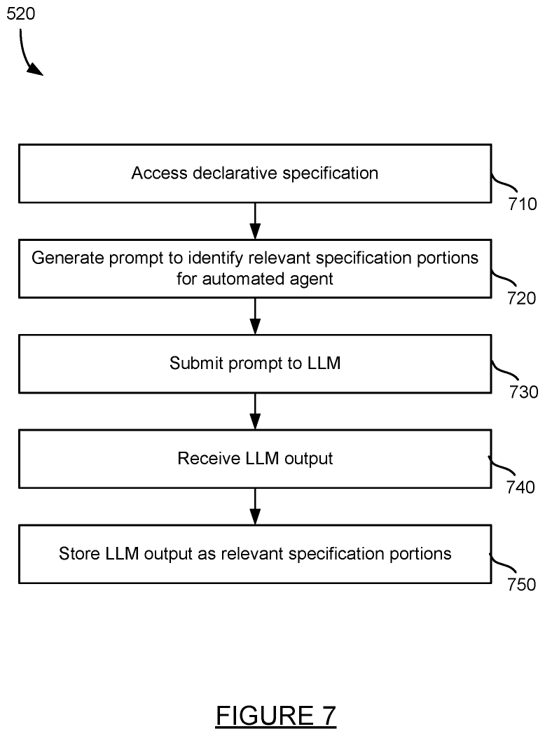

An automated agent is initialized from a declarative specification at step 520. The automated agent may be generated based on the policies of the specification. In some instances, a prompt is generated to identify relevant specification portions, or controls implemented as policies, for the automated agent. An LLM identifies the relevant specification portions and stores them for later use. Initializing an automated agent from a declarative specification is discussed in more detail with respect to FIG. 7.

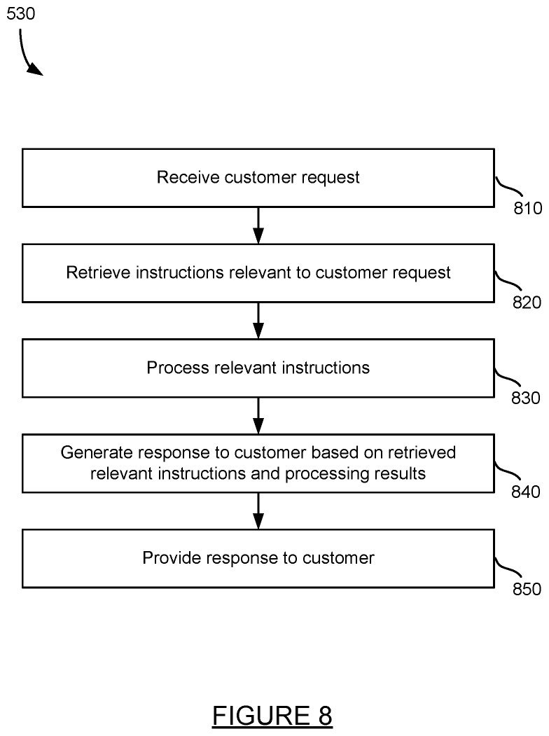

The automated agent engages in a conversation with a customer under specific controls at step 530. The conversation may be handled by conversation manager 230 of the automated agent application. More details for engaging in a conversation are discussed with respect to FIG. 8.

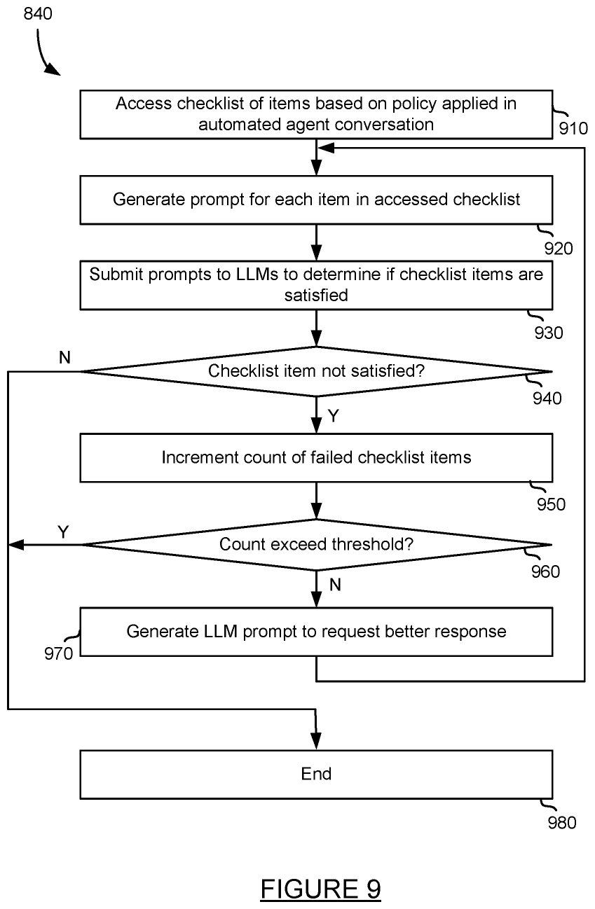

The automated agent's performance and conversation are evaluated based on controls at step 540. Evaluating an automated agent's performance may include accessing a checklist associated with policies applied during a conversation and auditing the checklist to determine if each item in the checklist is satisfied. More details associated with evaluating an automated agent's performance are discussed with respect to the method of FIG. 9.

FIG. 6 is a method for generating a declarative specification. FIG. 6 provides more details for step 510 the method of FIG. 5. First, in some instances, user conversation simulations may be run at step 610. The simulations may be run using automated agent posing as human customers. The conversations may be performed to cover items in the declarative specification to generate conversation data, which includes the text messages in the conversation, state data for the automated agent interacting with a customer, and other data associated with the conversation. In some instances, conversation data is based on past conversations between an automated agent and a human customer.

Next, examples or portions of conversations related to specific items in the specifications are extracted at step 620. The conversations may relate to how the automated agent handled specific tasks that are related to a particular general or specific policy.

General policies may be generated from the extracted examples at step 630. The general policies may relate to all conversations, regardless of the specific situation. Specific policies may be generated from examples at step 640. Specific policies are applied to conversations only for specific situations or states of the system handling the conversation. The declarative specification is assembled based on the general policies and specific policies generated at step 650.

FIG. 7 is a method for initiating an automated agent from a declarative specification. The method of FIG. 7 provides more detail for step 520 of the method of FIG. 5. A generated declarative specification is accessed at step 710. A prompt is then generated to identify relevant specification portions for an automated agent at step 720. The generated prompt may then be submitted to a large language model at step 730. A LLM receives the prompt, processes the prompt, and provides an output that indicates the relevant specification portions. The large language model output is received by the present system at step 740 and stored as a relevant specification portion at step 750.

FIG. 8 is a method for engaging in a conversation with a customer by an automated agent. The method of FIG. 8 provides more detail for step 530 of the method of FIG. 5. First, a customer request is received at step 810. Instructions relevant to the customer request are retrieved at step 820. The relevant instructions may be retrieved by requesting a large language model to identify the relevant instructions through a prompt. The prompt can include the customer request, one or more general or specific policies, optionally a set of instructions in addition to or in place of the policies, and a prompt request to identify the relevant customer instruction. Relevant instructions are received from the LLM and processed by the automated agent system.

A response to the customer is generated at step 840. The response may be generated based on retrieved relevant instructions and the processing results generated at step 830. Generating the response can include evaluating the response to determine if the response follows the policies (e.g., controls) properly. In some instances, the evaluation may include determining if the LLM response passes a checklist of items associated with one or more policies. Generating a response and evaluating the response is discussed in more detail with respect to the method of FIG. 9.

Once the response is evaluated to have properly followed any relevant policies, the response is provided to a customer at step 850.

FIG. 9 is a method for evaluating an automated agent response based on controls. The method of FIG. 9 provides more detail for step 840 of the method of FIG. 5. First, a checklist of items based on a policy applied in an automated agent conversation is accessed at step 910. A prompt is then generated for each item in the accessed checklist at step 920. Each prompt may include the check list item, portions of a conversation related to the checklist item, and a request to determine if the checklist item was followed in the conversation. The prompts for each checklist item are then submitted to one or more large language models to determine if the checklist items were satisfied at step 930. In some instances, each checklist item is evaluated by a separate LLM, such that the checklist items are evaluated in parallel.

If any of the LLM's determined that a checklist item was not satisfied, a count of failed checklist items is incremented at step 950. A determination is then made as to whether the count exceeds a threshold. In some instances, the present system will not process a checklist for an unlimited amount of time. Rather, the system only processes a checklist a threshold number of times, such as five, ten, twenty, or some other number of times, before determining that the process should be stopped.

Returning to step 960, if the account does exceed a threshold, the process ends at step 980 where the automated agent generates a message indicating that it is having an issue processing the customer request. If the count does not exceed threshold, an LLM prompt is generated to request a better response to the customer request with respect to the failed checklist item at step 970. The LLM prompt can include the customer request, the automated agent response, the checklist item and/or policy that was not properly failed, and a prompt request to determine a response that properly follows the checklist item and/or policy that was not followed correctly. The method of FIG. 9 then returns to step 920 where the generated prompt is accessed before being submitted to an LLM.

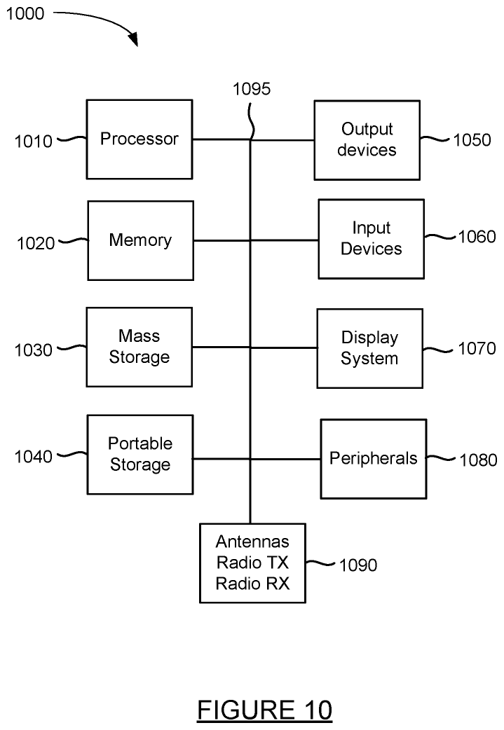

FIG. 10 is a block diagram of a computing environment for implementing the present technology. System 1000 of FIG. 10 may be implemented in the contexts of the likes of machines that implement machine learning model 110, application server 120, chat application server 130, and client device 100. The computing system 1000 of FIG. 10 includes one or more processors 1010 and memory 1020. Main memory 1020 stores, in part, instructions and data for execution by processor 1010. Main memory 1020 can store the executable code when in operation. The system 1000 of FIG. 10 further includes a mass storage device 1030, portable storage medium drive(s) 1040, output devices 1050, user input devices 1060, a graphics display 1070, and peripheral devices 1080.

The components shown in FIG. 10 are depicted as being connected via a single bus 1095. However, the components may be connected through one or more data transport means. For example, processor unit 1010 and main memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive, an optical disk drive, a flash drive, or other device, is a non-volatile storage device for storing data and instructions for use by processor unit 1010. Mass storage device 1030 can store the system software for implementing embodiments of the present invention for purposes of loading that software into main memory 1020.

Portable storage device 1040 operates in conjunction with a portable non-volatile storage medium, such as a floppy disk, compact disk or Digital video disc, USB drive, memory card or stick, or other portable or removable memory, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1000 as shown in FIG. 10 includes output devices 1050. Examples of suitable output devices include speakers, printers, network interfaces, and monitors.

Display system 1070 may include a liquid crystal display (LCD) or other suitable display device. Display system 1070 receives textual and graphical information and processes the information for output to the display device. Display system 1070 may also receive input as a touch-screen.

Peripherals 1080 may include any type of computer support device to add additional functionality to the computer system. For example, peripheral device(s) 1080 may include a modem or a router, printer, and other device.

The system of 1000 may also include, in some implementations, antennas, radio transmitters and radio receivers 1090. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, handheld computing device, smart phone, mobile computing device, tablet computer, workstation, server, minicomputer, mainframe computer, or any other computing device. The computer can also include different bus configurations, networked platforms, multi-processor platforms, etc. The computing device can be used to implement applications, virtual machines, computing nodes, and other computing units in different network computing platforms, including but not limited to AZURE by Microsoft Corporation, Google Cloud Platform (GCP) by Google Inc., AWS by Amazon Inc., IBM Cloud by IBM Inc., and other platforms, in different containers, virtual machines, and other software. Various operating systems can be used including UNIX, LINUX, WINDOWS, MACINTOSH OS, CHROME OS, IOS, ANDROID, as well as languages including Python, PHP, Java, Ruby, .NET, C, C++, Node.JS, SQL, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for providing controls for an automated agent, comprising:
generating declarative specification for an automated agent, the declarative specification including a general policy and a specific policy;
receiving conversation data, the conversation data associated with an interaction between the automated agent and a customer, the automated agent applying the declarative specification during the interaction; and
determining, by one or more machine learning mechanisms stored and executed on one or more servers, whether the declarative specification was followed by the automated agent during the interaction.

2. The method of claim 1, further including:
retrieving previous conversation data associated with one or more previous conversations;
extracting examples of conversation data associated with a declarative specification; and
generating one or more general policies or specific policies from the extracted examples.

3. The method of claim 1, wherein the general policy is applied to all subsequent automated agents.

4. The method of claim 1, wherein the specific policy is applied to a subset of subsequent automated agent in a particular state.

5. The method of claim 1, further including:
generating a checklist based on the declarative specification; and
processing the checklist and the conversation data by the one or more machine learning mechanisms to determine whether the declarative specification was followed by the automated agent during the interaction.

6. The method of claim 5, wherein each item in the checklist is processed by a separate machine learning mechanism of the plurality of machine learning mechanisms.

7. The method of claim 6, wherein each of the separate machine learning mechanisms include a large language model.

8. The method of claim 1, further comprising:
determining that the automated agent did not follow the declarative specification for an item in the checklist; and
submitting a portion of the conversation data associated with the checklist item and the declarative specification associated with the checklist item to a large language model to request a response that satisfies the declarative specification.

9. A non-transitory computer readable storage medium having embodied thereon a program, the program being executable by a processor to providing controls for an automated agent, the method comprising:
generating declarative specification for an automated agent, the declarative specification including a general policy and a specific policy;
receiving conversation data, the conversation data associated with an interaction between the automated agent and a customer, the automated agent applying the declarative specification during the interaction; and
determining, by one or more machine learning mechanisms stored and executed on one or more servers, whether the declarative specification was followed by the automated agent during the interaction.

10. The non-transitory computer readable storage medium of claim 9, the method further including:
retrieving previous conversation data associated with one or more previous conversations;
extracting examples of conversation data associated with a declarative specification; and
generating one or more general policies or specific policies from the extracted examples.

11. The non-transitory computer readable storage medium of claim 9, wherein the general policy is applied to all subsequent automated agents.

12. The non-transitory computer readable storage medium of claim 9, wherein the specific policy is applied to a subset of subsequent automated agent in a particular state.

13. The non-transitory computer readable storage medium of claim 9, the method further including:
generating a checklist based on the declarative specification; and
processing the checklist and the conversation data by the one or more machine learning mechanisms to determine whether the declarative specification was followed by the automated agent during the interaction.

14. The non-transitory computer readable storage medium of claim 13, wherein each item in the checklist is processed by a separate machine learning mechanism of the plurality of machine learning mechanisms.

15. The non-transitory computer readable storage medium of claim 14, wherein each of the separate machine learning mechanisms include a large language model.

16. The non-transitory computer readable storage medium of claim 9, the method further comprising:
determining that the automated agent did not follow the declarative specification for an item in the checklist; and
submitting a portion of the conversation data associated with the checklist item and the declarative specification associated with the checklist item to a large language model to request a response that satisfies the declarative specification.

17. A system for providing controls for an automated agent, comprising:
one or more servers, wherein each server includes a memory and a processor; and
one or more modules stored in the memory and executed by at least one of the one or more processors to generate declarative specification for an automated agent, the declarative specification including a general policy and a specific policy, receive conversation data, the conversation data associated with an interaction between the automated agent and a customer, the automated agent applying the declarative specification during the interaction, and determine, by one or more machine learning mechanisms stored and executed on one or more servers, whether the declarative specification was followed by the automated agent during the interaction.

18. The system of claim 17, the modules further executable to retrieve previous conversation data associated with one or more previous conversations, extract examples of conversation data associated with a declarative specification, and generate one or more general policies or specific policies from the extracted examples.

19. The system of claim 17, wherein the general policy is applied to all subsequent automated agents.

20. The system of claim 17, wherein the specific policy is applied to a subset of subsequent automated agent in a particular state.
